(19) United States
(12) Patent Application Publication
(10) Pub. No.: US 2011/0056513 A1
(43) Pub. Date: Mar. 10, 2011

(54) METHOD FOR TREATING SURFACES, LAMP FOR SAID METHOD, AND IRRADIATION SYSTEM HAVING SAID LAMP

(76) Inventors: Axel Hombach, Kurten (DE); Siegmar Rudakowski, Ratingen (DE)

(21) Appl. No.: 12/736,741

(22) PCT Filed: Jun. 5, 2008
(86) PCT No.: PCT/EP2008/056966

§ 371 Date: Nov. 5, 2010

(51) Int. Cl. C23F 1/08; H05H 1/48; B08B 7/00

(52) U.S. Cl. 134/1.1; 156/345.43

(57) ABSTRACT

The invention relates to a method for treating, particularly cleaning, modifying, and/or activating surfaces, using UV/VUV irradiation of a UV/VUV lamp and additional gas discharge. A dielectric barrier discharge lamp (1) is preferably used as the UV/VUV lamp, comprising a planar window segment (7) for emitting the UV/VUV radiation. The lamp (1) extends into a process chamber (17). The additional gas discharge is generated in the region of the outer side of the window segment (7) of the lamp (1). The substrate to be treated is disposed within the process chamber (17), near the window segment (7).

### TECHNICAL FIELD

The invention proceeds from a method for treating surfaces with the aid of ultraviolet (UV) and/or vacuum ultraviolet (VUV) radiation. Use is therefore made of electromagnetic radiation in the region from approximately 150 nm to 350 nm (UV) or approximately 150 nm to 200 nm (VUV) for the treatment, such as, inter alia, cleaning, modifying and/or activating, of surfaces. Examples of the treatment of surfaces with the aid of the inventive method are the removal of organic contaminants on glass surfaces in the production of liquid crystal screens (LCD), the removal of photoresists or the improvement of the wettability of surfaces, for example of wafers and other substrates in semiconductor fabrication.

Radiators that emit electromagnetic radiation in the UV/VUV spectral region, inter alia, are used for such methods. Particularly suitable are so-called dielectric barrier discharge lamps, which have proved to be particularly efficient UV/VUV radiators, particularly when they are operated by the pulsed operating method described in U.S. Pat. No. 5,604,410.

Document WO 03/098653 discloses a dielectric barrier discharge lamp that can be used in a vacuum chamber for process engineering methods by means of UV/VUV radiation such as, for example, surface cleaning and surface activation, photolysis, ozone generation, drinking-water purification, metalizing, and UV curing. The UV/VUV radiation is emitted by xenon excimers (Xe₂*) with wavelengths in the region of approximately 172 nm, which are generated in a dielectrically impeded discharge of 200 mbar xenon in the interior of the discharge vessel consisting of silica glass. A helical inner electrode is arranged axially in the interior of the tubular discharge vessel. Six strip-shaped electrodes are applied in parallel to the inner electrode on the outside of the discharge vessel. The inner electrode is guided from the inside to the outside in gastight fashion at one end of the discharge vessel by means of a sealing region. The other end of the discharge vessel is sealed in domed fashion and provided with a fused-off tip. That end of the inner electrode that is remote from the sealing region is fixed in the front tip.

Document US 2006/180173 A1 discloses a method for removing organic materials, for example paints from semiconductors. To this end, a xenon-filled dielectrically impeded discharge lamp is installed in a process chamber with an oxygen-containing subatmosperic pressure. The VUV radiation emitted by the lamp with wavelengths of approximately 172 nm generates ozone and activated oxygen in the oxygen-containing atmosphere.

### SUMMARY OF THE INVENTION

The object of the present invention is to provide an improved method for treating, in particular cleaning, modifying and/or activating, surfaces. A further aspect of the invention is to provide a UV/VUV radiator suitable for the method and an irradiation system having this UV/VUV radiator.

This object is achieved by a method for surface treatment, in particular cleaning, modification and/or activation, of an object in the interior of a process chamber with the aid of a UV/VUV radiator, the UV/VUV radiator having a radiator vessel that projects into the interior of the process chamber, and the method comprising the following method steps:
introducing into the process chamber the object whose surface is to be treated, in particular cleaned, modified and/or activated,
generating UV/VUV radiation by operating the UV/VUV radiator, the radiation passing into the interior of the process chamber through the wall of the radiator vessel, which wall is transparent to the UV/VUV radiation,

characterized by the following additional method step: generating a gas discharge in the region of at least a part of the outer wall of the radiator vessel.

Furthermore, with regard to a UV/VUV radiator suitable for carrying out the inventive method, a dielectric barrier discharge lamp as claimed in independent claim 8 directed thereto is claimed. Finally, an irradiation system for carrying out the inventive method with the aid of this dielectric barrier discharge lamp as UV/VUV radiator as claimed in independent claim 16 directed thereto is also claimed.

Particularly advantageous refinements are to be found in the respective dependent claims.

The method claims also comprise device features and the device claims also comprise, conversely, method features, and so the two categories are not always strictly separated below, but are predominantly explained in their mutual interaction.

The basic idea of the inventive method consists in using not only the radiation of a UV/VUV radiator for treating, in particular cleaning, modifying and/or activating, the surface of a substrate, but also, moreover, in generating a gas discharge in the region of at least a part of the outer wall of the vessel of the UV/VUV radiator, that is to say in the vicinity of the substrate. Specifically, the inventors have found that this leads to a substantial improvement in the action of treating, in particular cleaning, modifying and/or activating, the surface of the substrate. Without thereby wishing to settle on one theoretical interpretation, it is assumed in this case that the electrons, ions, radicals, metastables and/or chemically reactive species generated in the process chamber by the additional discharge make a contribution.

By contrast with conventional surface cleaning, for example by means of plasma etching, the inventive method has, inter alia, the advantage that, for example, the discharge in a dielectric barrier discharge lamp for generating the UV/VUV radiation is separate from the additional discharge in the atmosphere of the process chamber. This results in a degree of freedom for optimizing the discharge inside the UV/VUV radiator independently of the additional discharge inside the process chamber. Moreover, the discharge for generating the UV/VUV radiation is not negatively influenced by the gas components of the atmosphere of the process chamber or by the contaminants of the substrate to be treated, in particular to be cleaned.

It is preferred to make use as UV/VUV radiator for the inventive method of a dielectric barrier discharge lamp whose tubular discharge vessel projects into the process chamber. The discharge medium is enclosed in gastight fashion in the tubular discharge vessel. It is thereby possible to suitably select for the discharge medium of the dielectric barrier discharge both the gas type, for example xenon, and the gas pressure, for example 100 mbar or more, with regard to as high as possible an efficiency or power of the generation of UV/VUV radiation.

The additional gas discharge is, by contrast, generated separately therefrom in the region of at least a part of the outer wall of the discharge vessel, in particular also substantially localized on the surface of the outer wall of the discharge vessel, that is to say in any event in the low pressure atmosphere of the process chamber, and thus at least in the vicinity of the substrate to be treated. Depending on the type of substrate and its contamination and/or the targeted treatment, the atmosphere of the process chamber can include, in particular, one or more of the components of oxygen, hydrogen, argon, SF₆, NH₃, halogen or compounds of the latter, usually at a total pressure in the range of typically 0.01 mbar to 20 mbar. In particular, the additional gas discharge, in particular a glow discharge, can be generated on the outside of the discharge vessel owing to the possibility of different pressure ranges for the discharge medium inside the discharge vessel of the UV/VUV radiator, on the one hand, and for the atmosphere inside the process chamber, on the other hand, but also owing to a suitable electrical design and to the mode of operation of the UV/VUV radiator. Reference may be made to the following section and to the exemplary embodiment for further details of this.

In one embodiment, an elongated, preferably helical, inner electrode is arranged axially inside the tubular discharge vessel. The inner electrode is guided to the outside in gastight fashion through a sealing region at a first end of the discharge vessel. Arranged on the outside of the discharge vessel is at least one elongated, for example strip-shaped, outer electrode that extends, starting from the end of the sealing region of the inner electrode, parallel to the longitudinal axis of the tubular discharge vessel. At the other end averted from the sealing region, the front of the discharge vessel is designed as a window section that serves to transmit the UV/VUV radiation generated during operation. It is preferred for the additional discharge to be generated in the region of the outside of this window section. To this end, it has proved to be advantageous when the front window section is substantially planar or domed. The UV/VUV radiation passing through the window section is thereby disturbed to the least extent. For this reason, an exhaust tube that is required as a rule in the production of the lamp and is fused off after the discharge vessel is filled with the discharge medium is also arranged either in the region of the circumference or of that end of the tubular discharge vessel that is averted from the front window section. Moreover, this form of vessel, together with suitably configured electrodes, enables an additional discharge, preferably a glow discharge, to be generated in the region of the outside of the window section. It has proved to be advantageous in this context when the at least one elongated outer electrode preferably ends approximately 3 to 10 mm in front of the front window section. The distance of the front end of the inner electrode from the front window section is preferably equal to or less than the corresponding distance of the at least one outer electrode. It is assumed from the present state of knowledge that the field punch-through of the inner electrode then firstly enables a sufficiently intensive gas discharge on the outer wall of the window section.

Alternatively, it is also possible for the generally metal process chamber to serve as outer electrode. It is then possible to dispense with the elongated outer electrodes on the outside of the discharge vessel on the dielectric barrier discharge lamp.

Moreover, it has proved to be advantageous for an optimum tuning between UV/VUV radiation and additional gas discharge when the ratio of length to diameter of the tubular discharge vessel is at most 2:1. Since the dielectric barrier discharge burns substantially radially from the axial inner electrode in the direction of the outer electrodes, the diameter of the discharge vessel is defined by twice the striking distance of the dielectric barrier discharge. On the other hand, the UV/VUV radiation efficiency of the dielectric barrier discharge is a function of the striking distance or the value of the electric voltage required therefor. Consequently, the diameter of the discharge vessel can vary only within certain limits without the need to accept a clear deterioration of the UV/VUV radiation efficiency. An excessively small diameter, and thus an excessively small striking distance, is, in addition, detrimental to a sufficiently high UV/VUV radiant power. The suitable length/diameter ratio is therefore substantially set by a not excessively great length of the discharge vessel. The decisive length of the discharge vessel is in this case the region along which the inner and outer electrodes are situated opposite, that is to say the longitudinal section of the discharge vessel inside which a dielectrically impeded discharge burns during operation of the lamp.

### BRIEF DESCRIPTION OF THE DRAWINGS

The aim below is to describe the invention in more detail with the aid of exemplary embodiments. In the figures:

FIG. 1a shows a side view of an inventive dielectric barrier discharge lamp with base,

FIG. 1b shows a front view of the lamp from FIG. 1a,

FIG. 2 shows a side view of the lamp from FIG. 1a without base, and

FIG. 3 shows a partial sectional view of a process chamber in which the lamp from FIG. 1 is installed.

### PREFERRED DESIGN OF THE INVENTION

Elements that are the same or functionally the same are provided in the figures with the same reference symbols.

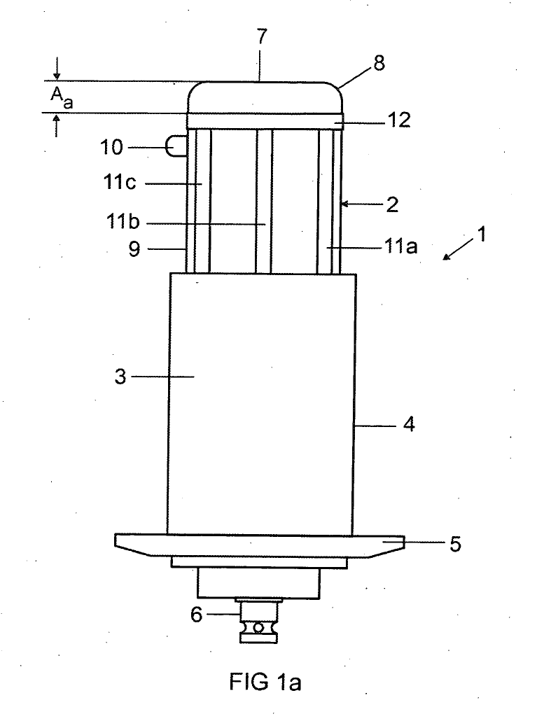

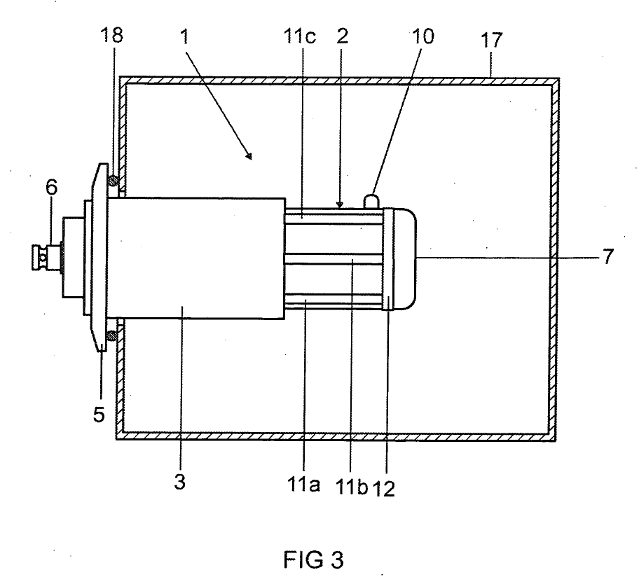

FIGS. 1a and 1b respectively show a side view and a front view of an exemplary embodiment of the inventive dielectric barrier discharge lamp 1. This dielectric barrier discharge lamp 1 is provided as a UV/VUV radiator in the inventive surface treating method, in particular cleaning and/or modifying or activating method. The lamp 1 has a tubular discharge vessel 2 of circular cross section that has a diameter of approximately 45 mm and consists of silica glass. At one end, the lamp 1 has a tubular base 3 made from aluminum and from which the discharge vessel 2 projects over a length of approximately 60 mm. The base 3 itself essentially consists of a base shell 4 having a length of approximately 90 mm and to which a flange 5 is connected. The lamp 1 is installed in gastight fashion in a process chamber with the aid of this flange 5 (see FIG. 3). At the end, the flange 5 has a bush 6 for connecting the lamp 1 electrically to a supply device (not illustrated). At the other end, the discharge vessel 2 has a substantially planar section 7 that serves as window for the undisturbed transmission of the UV/VUV radiation generated inside the discharge vessel during operation. Via an annular, curved transition section 8, the planar window section 7 merges into the actual tubular section 9 of the discharge vessel 2. Since the transition section 8 is of relatively narrow design, virtually the entire diameter of the discharge vessel 2 is available for the planar region of the window section 7. An exhaust tube 10 that is fused off after the evacuation and filling of the discharge vessel 2 with xenon gas at a filling pressure of approximately 100 mbar is arranged at the side below the transition section 8 on the tubular section 9 of the discharge vessel 2 and not, as is usually the case with such lamp types, on the end face. Alternatively, the exhaust tube 10 can also be arranged at the end of the discharge vessel on the base side. In both cases, the front window section 7 avoids optical interference.

Six strip-shaped outer electrodes 11a-11f made from aluminum strips with a width of 4 mm are arranged parallel to the lamp longitudinal axis on the outside of the discharge vessel 2. At the end on the base side, the outer electrodes 11a-11f are connected to the bush 6 via the base shell 4 (not illustrated). The front ends of the outer electrodes 11a-11f are interconnected or held together by means of an annular electrode strip 12. The outer electrodes 11a-11f or, more precisely, the annular electrode strip 12, connecting their ends, ends at the distance Aₐ of approximately 10 mm in front of the planar window section 7. Since the outer electrodes 11a-11f end approximately 10 mm below the base edge, the decisive length/diameter ratio for the discharge vessel is approximately 60 mm:45 mm, that is to say roughly 1.3:1.

Alternatively, the outer electrodes can also be applied, for example printed on, as linear electrode tracks, for example by means of conductive paste. It is then also possible to dispense with the annular electrode strip at the front end.

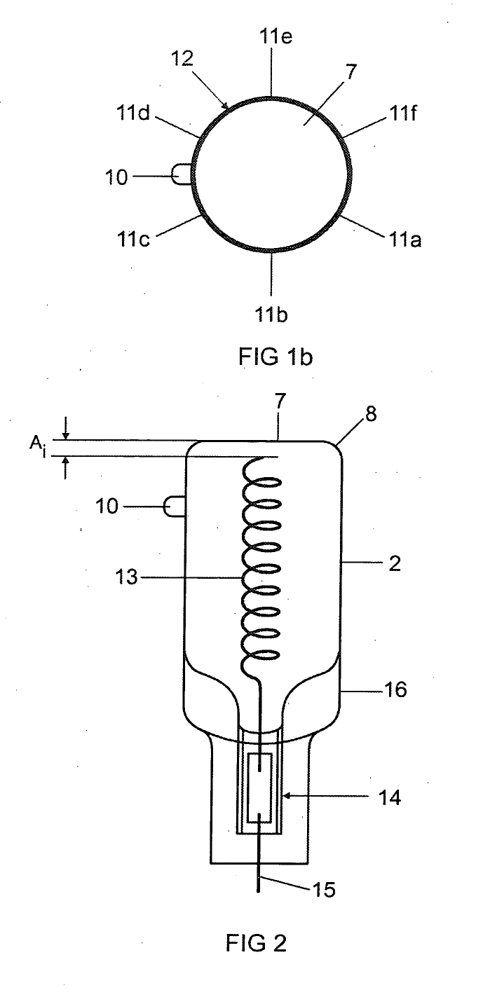

For the explanations of further features of the lamp 1 that are not visible in FIGS. 1a, 1b, reference is also made below to FIG. 2, which shows a schematic of a side view of the lamp 1 without base. A helical inner electrode 13 is axially arranged inside the tubular discharge vessel 2. It may be mentioned at this juncture that it is also possible in principle to design the outer electrode as a helix, and to design the associated inner electrode as an axially arranged straight wire or rod. What is decisive in this context is only that a discharge structure disclosed in DE 196 36 965 A1 in FIG. 5c results in the case of a pulsed mode of operation in accordance with U.S. Pat. No. 5,604,410 mentioned at the beginning. The helical inner electrode 13 consists of a metal wire with a wire diameter of 1 mm. The diameter of the electrode helix 13 is 10 mm, and the pitch is 13 mm. At the front end of the discharge vessel 2, the helical inner electrode 13 ends at the distance Aᵢ of approximately 5 mm in front of the window section 7. At the other end of the discharge vessel 2, that is to say on the lamp foot side, the inner electrode 13 is guided in gastight fashion through a sealing region 14 designed as a foil seal to the outside, and ends there in the form of a pin-type outer supply lead 15. The outer supply lead 15 is connected to the bush 6 (not illustrated) during mounting of the base 3. As mentioned, the strip-shaped outer electrodes 11a-11f not illustrated in FIG. 2 are connected to the metal base shell 4 and are connected to frame potential for safety reasons. Attached at the end of the discharge vessel 2 on the lamp foot side is a glass tube extension 16 that is connected in gastight fashion to the inside of the base shell 4 via a conventional Viton seal during mounting of the base. The advantage of this measure is explained below with reference to FIG. 3.

FIG. 3 shows a very schematic illustration of a process chamber 17 in which the lamp 1 illustrated in FIGS. 1a, 1b and 2 is installed. For this purpose, the process chamber 17 has an opening through which the discharge vessel 2 of the lamp 1 projects into the process chamber 17. The opening is closed in gastight fashion by means of an O-ring seal 18 through the flange 5 of the lamp base 3. Moreover, the abovementioned Viton seal between the glass tube extension 16 on the discharge vessel 2 and the inside of the base shell 4 has the effect that the supply lead 15 running inside the glass tube extension 16 is not exposed to the subatmospheric pressure of the process chamber, and that undesired parasitic discharges therefore do not occur. Instead of this, the supply lead 15 is separated in gastight fashion from the subatmospheric pressure inside the process chamber 17 by the glass tube extension 16, the base shell 4 and the Viton seal between these two, and is subject to normal environmental conditions. Reference may be made to WO 03/098653 already mentioned for further details relating to the gas seal by means of the glass tube extension and base. The process chamber 17 is filled with an Ar/H₂ mixture with a pressure of 0.1 mbar. For the sake of simplicity, the pump and gas system for evacuating and filling the process chamber that is customary for this purpose is not illustrated. Likewise not illustrated is the substrate, which is also located in the process chamber, for example silicon, whose surface is to be treated, for example cleaned, modified and/or activated. The distance of the substrate from the front face 7 of the lamp is typically approximately 1 mm to 1 cm. Via the bush 6, the lamp 1 is connected to an electrical supply device (not illustrated) that supplies high voltage pulses of approximately 5 kV and of a pulse width of 100 ns that are separated from one another by pauses of approximately 20 μs. The electric power in this example is approximately 10 W. This is used to operate a dielectric barrier discharge inside the discharge vessel 2, and additionally to generate a glow discharge in the process chamber 17 in the region in front of the window section 7 of the lamp 1 (not illustrated) which, together with the UV/VUV radiation generated by the dielectric barrier discharge, serves the purpose of the inventive cleaning, modification or activation of the surface of a material (not illustrated) introduced into the process chamber 17.

The walls of the process chamber 17, which usually consist of stainless steel and are at frame potential for reasons of safety, can also be used as alternative outer electrodes for the lamp 1. It is then possible to dispense with the strip-shaped outer electrodes 11a-11f otherwise usually arranged on the outside of the discharge vessel 2 (not illustrated). If necessary, all that remains is for the internal pressure in the process chamber 17 and in the discharge vessel 2 of the lamp 1 to be respectively set as appropriate in order for a discharge to burn during operation both in the discharge vessel 2 and inside the process chamber, preferably immediately in front of the window section 7. Moreover, instead of or in addition to the process chamber, it is also possible to provide an (auxiliary) electrode as outer electrode, for example a metal rod projecting into the chamber, or else a metal support for the substrate to be treated.

1. A method for surface treatment, in particular cleaning, modification and/or activation, of an object in the interior of a process chamber (17) with the aid of a UV/VUV radiator (1),
the UV/VUV radiator (1) having a radiator vessel (2) that projects into the interior of the process chamber (17),
the method comprising the following method steps:
introducing into the process chamber (17) the object whose surface is to be treated, in particular cleaned, modified and/or activated,
generating UV/VUV radiation by operating the UV/VUV radiator (1), the UV/VUV radiation passing into the interior of the process chamber (17) through the wall of the radiator vessel (2), which wall is transparent to the UV/VUV radiation,
characterized by the following additional method step:
generating a gas discharge in the region of at least a part (7) of the outer wall of the radiator vessel (2).

2. The method as claimed in claim 1, in which the process chamber (17) is filled with a gas or gas mixture at a total pressure in the range from 0.01 mbar to 20 mbar.

3. The method as claimed in claim 2, in which the gas or gas mixture is or includes the following components: oxygen, hydrogen, argon, SF₆, NH₃, halogen or compounds of the latter.

4. The method as claimed in claim 1, in which the radiator vessel (2) is tubular, and the gas discharge is generated in the outer region of the sealed end (7), projecting into the process chamber (17), of the radiator vessel.

5. The method as claimed in claim 1, in which the UV/VUV radiator (1) is designed and operated such that the gas discharge outside the radiator vessel is a glow discharge.

6. The method as claimed in claim 1, in which the UV/VUV radiator (1) is a dielectric barrier discharge lamp.

7. The method as claimed in claim 6, in which the discharge lamp (1) is operated by pulsed high voltage.

8. A dielectric barrier discharge lamp (1), suitable as a UV/VUV radiator for the method as claimed in claim 1, having
a tubular discharge vessel (2) that is sealed at both its ends in gastight fashion and thus forms a discharge space that is filled with a discharge medium,
an elongated inner electrode (13) that is arranged axially inside the discharge vessel (2) and is guided to the outside in gastight fashion through a sealing region (14) at a first end of the discharge vessel,
an outer electrode (11a-11f) that is arranged outside the discharge vessel (2),
characterized in that
a second end of the discharge vessel is designed as a front window section (7) that serves to transmit the UV/VUV radiation generated during operation.

9. The lamp as claimed in claim 8, in which the front window section (7) is substantially planar or domed.

10. The lamp as claimed in claim 8, in which the ratio of length to diameter of the tubular discharge vessel (2) is at most 2:1.

11. The lamp as claimed in claim 1, in which the outer electrode is designed as at least one elongated electrode (11a-11f) arranged on the outside of the discharge vessel (2) and which extends, starting from the sealing region of the inner electrode, parallel to the longitudinal axis of the tubular discharge vessel (2) and ends in front of the front window section (7).

12. The lamp as claimed in claim 11, in which the at least one elongated outer electrode (11a-11f) ends at a distance (Aₐ) of approximately 3 to 10 mm in front of the front window section (7).

13. The lamp as claimed in claim 8, in which the distance (Aᵢ) between the front window section (7) and the front end of the inner electrode (13) is equal to or less than the corresponding distance (Aₐ) of the at least one elongated outer electrode (10a-10f).

14. The lamp as claimed in claim 8, in which the outer electrode is designed as a metal chamber (17) into which the discharge vessel (2) projects through an opening, the opening being closed in gastight fashion via the base (3) of the lamp (1).

15. The lamp as claimed in claim 8, having a fused-off exhaust tube (10) that is arranged either in the region of the tubular section (9) or of that end of the tubular discharge vessel (2) that is averted from the front window section (7).

16. An irradiation system having a process chamber (17) in which a lamp (1) is installed in order to carry out the method as claimed in claim 1, the lamp comprising
a tubular discharge vessel (2) that is sealed at both its ends in gastight fashion and thus forms a discharge space that is filled with a discharge medium,
an elongated inner electrode (13) that is arranged axially inside the discharge vessel (2) and is guided to the outside in gastight fashion through a sealing region (14) at a first end of the discharge vessel, and
an outer electrode (11a-11f) that is arranged outside the discharge vessel (2),
wherein a second end of the discharge vessel is designed as a front window section (7) that serves to transmit the UV/VUV radiation generated during operation.

17. The irradiation system as claimed in claim 16, in which the process chamber (17) has an opening through which the discharge vessel (2) of the lamp (1) projects into the process chamber (17), the opening being closed in gastight fashion by the base (3) of the lamp (1), and the outer supply lead (15) of the lamp (1) inside the base (3) being designed in gastight fashion with respect to the atmosphere inside the process chamber (17).

18. The irradiation system as claimed in claim 17, in which the process chamber consists of an electrically conductive material and is designed as outer electrode for the lamp.

19. The irradiation system as claimed in claim 17, in which a conductor projects into the process chamber, the conductor being designed as outer electrode for the lamp.

20. The irradiation system as claimed in claim 16, in which the lamp is connected to an electrical supply device suitable for operating the lamp.
